(19) United States
(12) Patent Application Publication
(10) Pub. No.: US 2026/0322191 A1
(43) Pub. Date: Oct. 15, 2026

(54) ROTATING ELECTRICAL MACHINE

(71) Applicant: Honda Motor Co., Ltd., Tokyo (JP)

(72) Inventor: Kazuki Ito, Tokyo (JP)

(21) Appl. No.: 19/464,898

(22) Filed: Jan. 30, 2026

(30) Foreign Application Priority Data
Feb. 13, 2025 (JP) 2025-021340

(51) Int. Cl. H02K 1/20; H02K 1/16

(52) U.S. Cl. CPC H02K 1/20; H02K 1/16

(57) ABSTRACT

A rotating electrical machine including a rotor and a stator core having a plurality of axially stacked core blocks. The stator core includes first and second adjacent core blocks, and each core block includes: first and second slot groups arranged alternately in a circumferential direction, each group having slots extending radially; first flow paths communicating with radially outer ends of the first slots; and second flow paths extending circumferentially on a radially outer side of the second slot groups. End portions of the second flow paths in one core block are located within slot regions defined by radially outward extensions of end first slots of the other core block. The core blocks are stacked such that the first flow paths of the first core block communicate with the second flow paths of the second core block, and vice-versa.

### CROSS-REFERENCE TO RELATED APPLICATION

This application is based upon and claims the benefit of priority from Japanese Patent Application No. 2025-021340 filed on Feb. 13, 2025, the content of which is incorporated herein by reference.

### BACKGROUND OF THE INVENTION

### Field of the Invention

This invention relates to a rotating electrical machine.

### Description of the Related Art

In recent years, research and development have been conducted on rotating electrical machines that contribute to energy efficiency, ensuring access to affordable, reliable, and sustainable advanced energy for more people. As such a rotating electrical machine, there are known rotating electrical machines where a refrigerant circulates through the stator core to cool the stator. Such a rotating electrical machine is described, for example, in Japanese Examined Patent Publication No. 6387035 (JP6387035B).

By cooling the stator core with a refrigerant, the stator coils in the slots are indirectly cooled through the stator core. In the rotating electrical machine described in JP6387035B, multiple core blocks with circumferential flow paths formed at a predetermined circumferential angle range are stacked, thereby constituting circumferential flow paths over the entire perimeter of the stator core. More specifically, each of a pair of adjacent core blocks is formed with a circumferential flow path, configured to overlap with each other's end regions by offsetting their circumferential phases, thereby connecting the circumferential flow paths.

In this regard, when the circumferential phases of the multiple core blocks are offset to overlap each end region and connect the circumferential flow paths, pressure loss at the connection becomes an issue.

### SUMMARY OF THE INVENTION

An aspect of the present invention is a rotating electrical machine including a rotor extending along an axial direction, and a stator core having a plurality of core blocks stacked in the axial direction and formed to surround the rotor. The plurality of core blocks include a first core block and a second core block adjacent to each other in the axial direction, each of the first core block and the second core block includes: a plurality of first slot groups arranged in a circumferential direction, each first slot group including a plurality of first slots arranged in the circumferential direction, each first slot extending in a radial direction; a plurality of second slot groups arranged in the circumferential direction and disposed alternately with each of the plurality of first slot groups in the circumferential direction, each second slot group including a plurality of second slots arranged in the circumferential direction, each second slot extending in the radial direction; a plurality of first flow paths extending radially outward to communicate with end portions on a radially outer side of the plurality of first slots; and a plurality of second flow paths arranged in the circumferential direction, each second flow path extending in the circumferential direction on the radially outer side of each second slot group. The plurality of first slots include end first slots disposed at circumferential end portions, end portions of the plurality of second flow paths of the first core block are located within slot regions defined by radially outward extensions of the end first slots of the second core block, end portions of the plurality of second flow paths of the second core block are located within slot regions defined by radially outward extensions of the end first slots of the first core block, and the first core block and the second core block are stacked such that the plurality of first flow paths of the first core block communicate with one of the plurality of second flow paths of the second core block, and the plurality of first flow paths of the second core block communicate with one of the plurality of second flow paths of the first core block.

### BRIEF DESCRIPTION OF THE DRAWINGS

The objects, features, and advantages of the present invention will become clearer from the following description of embodiments in relation to the attached drawings, in which:

FIG. 1 is a cross-sectional view illustrating a schematic configuration of a rotating electrical machine according to an embodiment of the present invention;

FIG. 2 is a front view illustrating a configuration of an outer core block in FIG. 1;

FIG. 3 is a front view illustrating a configuration of a central core block in FIG. 1;

FIG. 4 is a front view illustrating a configuration of an inner core block in FIG. 1;

FIG. 5 is a cross-sectional view taken along line A-A in FIG. 1;

FIG. 6 is a cross-sectional view taken along line B-B in FIG. 5;

FIG. 7 is a cross-sectional view illustrating a configuration of a main part of a slot;

FIG. 8 is a diagram illustrating a positional relationship between flow paths and a slot formed in the core block in FIG. 1; and

FIG. 9 is a diagram illustrating a modification of FIG. 7.

### DETAILED DESCRIPTION OF THE INVENTION

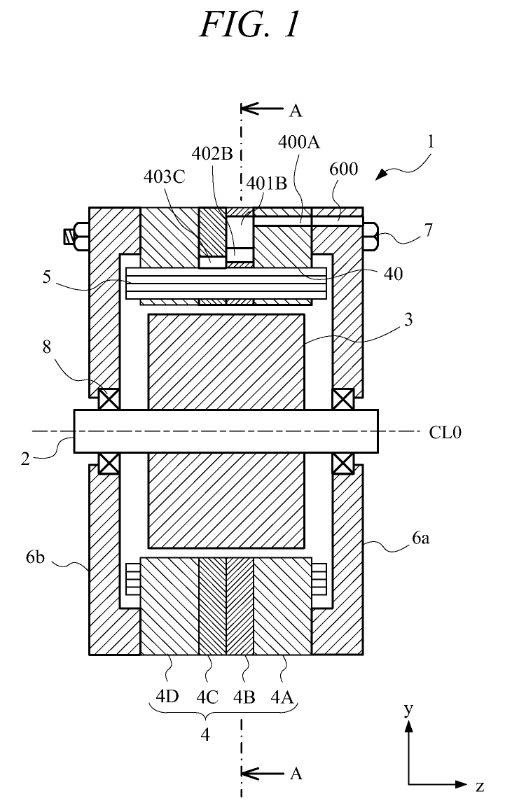

Hereinafter, embodiments of the present invention will be described with reference to FIGS. 1-9.

FIG. 1 is a diagram illustrating an overall schematic configuration of a rotating electrical machine 1 according to an embodiment of the present invention, and is a cross-sectional view taken along an axial direction of a rotor shaft 2. Hereinafter, for convenience, a direction along an axis CL0 is defined as a Z direction (axial direction), a direction radially extending from the axis CL0 is defined as a radial direction (Y direction), a direction along a peripheral surface of a circle centered on the axis CL0 is defined as a circumferential direction (X direction), and a configuration of each unit will be described according to this definition.

As illustrated in FIG. 1, the rotating electrical machine 1 includes the rotor shaft 2 extending along the axis CL0 in a z-axis direction (axial direction), a substantially cylindrical rotor 3 fixed to an outer peripheral surface of the rotor shaft 2, a substantially cylindrical stator core 4 arranged so as to surround an outer peripheral surface of the rotor 3, a stator coil 5 provided in a slot 40 of the stator core 4, and cases 6a and 6b.

The stator core 4 includes a plurality of core blocks 4A, 4B, 4C, and 4D stacked in the axial direction, and is sandwiched between the cases 6a and 6b arranged on both axial end surfaces of the stator core 4. That is, the case 6a, the core block 4A, the core block 4B, the core block 4C, the core block 4D, and the case 6b are sequentially arranged adjacent to each other in the axial direction. Each of the core blocks 4A, 4B, 4C, and 4D is formed by stacking a plurality of electromagnetic steel plates. Hereinafter, the core blocks 4A, 4B, and 4C may be referred to as an outer core block, a central core block, and an inner core block, respectively, for convenience. The stator core 4 is integrally fixed to the cases 6a and 6b by a plurality of bolts 7. The rotor shaft 2 is rotatably supported by bearings 8 provided on the cases 6a and 6b.

A conventional rotating electrical machine, for example, a rotating electrical machine described in JP 6387035 B is configured to supply a refrigerant (for example, cooling oil) to a refrigerant flow path formed in a stator core in order to suppress a temperature rise due to heat generation of a stator coil. On the other hand, the rotating electrical machine 1 of the present embodiment is configured such that the refrigerant supplied to the refrigerant flow path of the stator core 4 is guided into the slot 40 in which the stator coil 5 is accommodated, and the stator coil 5 is directly cooled by the refrigerant. Therefore, the cooling effect on the stator coil 5 can be improved.

In the case 6a, a flow path 600 is formed along the axial direction (Z direction), and the refrigerant is supplied into the case 6a via the flow path 600. The supplied refrigerant flows into a flow path 400A formed in the outer core block 4A along the axial direction. The refrigerant flowing into the flow path 400A flows into a flow path 401B formed along the radial direction (Y direction) in the central core block 4B. The refrigerant flowing into the flow path 401B flows into a flow path 402B formed along the circumferential direction (X direction) in the central core block 4B. The refrigerant flowing into the flow path 402B flows into a flow path 403C formed along the radial direction in the inner core block 4C, and the refrigerant flowing into the flow path 403C flows into the slot 40 (that is, the slot 40 of the stator core 4) of the inner core block 4C. The refrigerant flowing into the slot 40 flows in the axial direction through a gap between the slot 40 and the stator coil 5, and flows out from both axial ends of the stator core 4 toward the cases 6a and 6b.

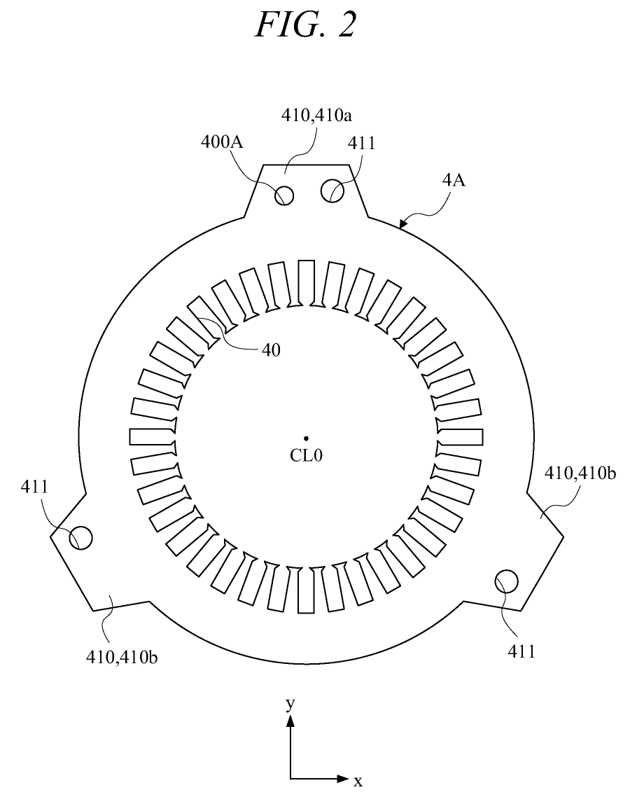

FIG. 2 is a front view illustrating a configuration of the outer core block 4A in FIG. 1. As illustrated in FIG. 2A, the outer core block 4A is formed in a substantially annular shape, and a plurality of slots 40 are formed radially outward on an inner peripheral surface of the outer core block 4A at equal intervals in the circumferential direction. On the outer peripheral surface of the outer core block 4A, a plurality of fastening portions 410 in which bolt fastening holes 411 are formed are provided at equal intervals (phase 120°) in the circumferential direction so as to protrude radially outward. The fastening portion 410 has a single fastening portion 410A and a plurality of other fastening portions 410B formed at the top of the outer core block 4A. In the fastening portion 410a, the flow path 400A penetrating the outer core block 4A in the axial direction is formed in addition to the bolt fastening hole 411.

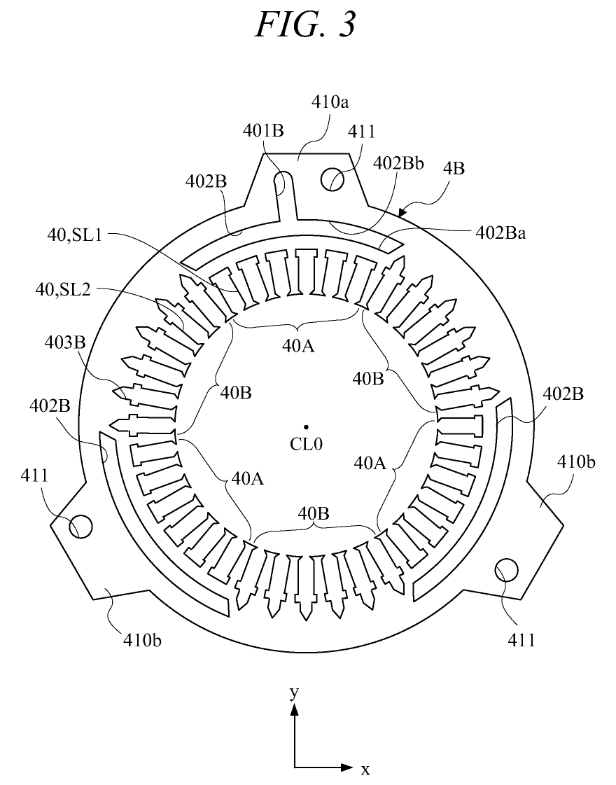

FIG. 3 is a front view illustrating a configuration of the central core block 4B. As illustrated in FIG. 3, the central core block 4B is formed in a substantially annular shape similarly to the outer core block 4A, and has a plurality of slots 40 formed radially outward at equal intervals in the circumferential direction on the inner peripheral surface thereof, and a plurality of fastening portions 410a and 410b formed on the outer peripheral surface thereof. A plurality of flow paths 402B extending in the circumferential direction is formed at equal intervals in the circumferential direction on the radially outer side of the slot 40. Specifically, three flow paths 402B are formed at intervals of 120°.

The flow path 402B has an inner peripheral surface 402Ba and an outer peripheral surface 402Bb centered on the axis CL0. The circumferential end of the outer peripheral surface 402Bb protrudes in the circumferential direction from the circumferential end of the inner peripheral surface 402Ba. The flow path 401B extending radially inward from the fastening portion 410a communicates with the flow path 402B at the top of the three flow paths 402B. The outer diameter side end of the flow path 401B is formed at a position overlapping the flow path 400A of the outer core block 4A in front view. That is, the outer diameter side end of the flow path 401B faces the flow path 400A of the outer core block 4A, and the flow paths 401B and 400A communicate with each other.

The plurality of slots 40 formed in the central core block 4B includes two types of slots SL1 and SL2 having different shapes. Unlike the slot SL1, the slot SL2 has a flow path 403B extending radially outward from the outer diameter side end thereof. The slot SL1 may be referred to as a reference slot, and the slot SL2 may be referred to as an extension slot.

In the central core block 4B, a reference slot group 40A which is a set of a plurality of reference slots SL1 and an extension slot group 40B which is a set of a plurality of extension slots SL2 are alternately provided in the circumferential direction. More specifically, the reference slot group 40A includes a predetermined number (for example, six) of the reference slots SL1 provided at equal intervals in the circumferential direction, and the extension slot group 40B includes a predetermined number (for example, six) of the extension slots SL2 provided at equal intervals in the circumferential direction. The reference slot groups 40A and the extension slot groups 40B are provided in the same number (for example, 3), and are alternately arranged in the circumferential direction over a predetermined phase of 120°. On the radially outer side of the reference slot group 40A, the flow path 402B extends in the circumferential direction over the entire region of the reference slot group 40A.

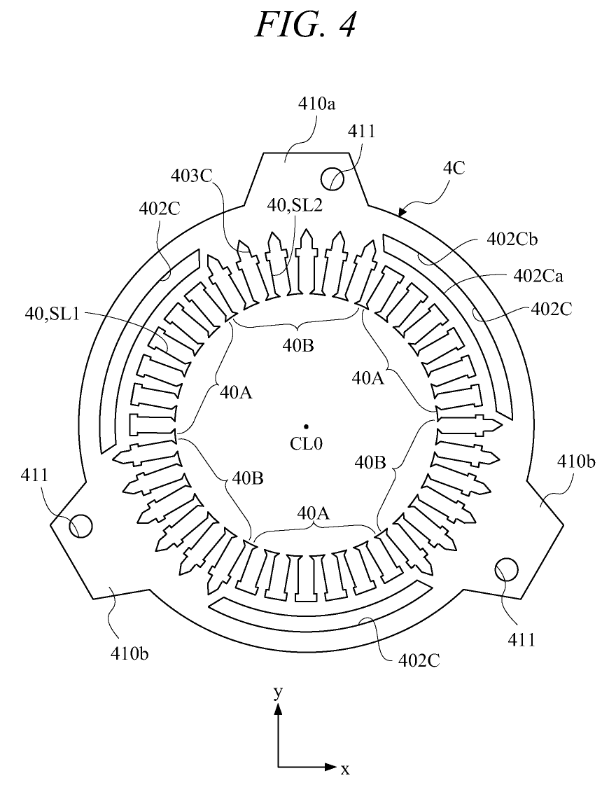

FIG. 4 is a front view illustrating a configuration of the inner core block 4C. As illustrated in FIG. 4, the inner core block 4C is formed in a substantially annular shape similarly to the outer core block 4A, and has a plurality of slots 40 formed radially outward at equal intervals in the circumferential direction on the inner peripheral surface thereof, and a plurality of fastening portions 410a and 410b formed on the outer peripheral surface thereof. A plurality of flow paths 402C extending in the circumferential direction is formed at equal intervals in the circumferential direction on the radially outer side of the slot 40. Specifically, three flow paths 402C are formed at intervals of 120°.

The flow path 402C is formed so as to be shifted in phase by 60° in the circumferential direction with respect to the flow path 402B. The flow path 402C has an inner peripheral surface 402Ca and an outer peripheral surface 402Cb centered on the axis CL0. The diameters of the inner peripheral surface 402Ba and the outer peripheral surface 402Bb of the flow path 402B are the same as the diameters of the inner peripheral surface 402Ca and the outer peripheral surface 402Cb of the flow path 402C. The circumferential length of the flow path 402C is the same as the circumferential length of the flow path 402B. Similarly to the flow path 402B of the central core block 4B, the circumferential end of the outer peripheral surface 402Cb of the flow path 402C protrudes in the circumferential direction from the circumferential end of the inner peripheral surface 402Ba. That is, the flow path 402B and the flow path 402C have the same shape only by shifting the phase by 60°. However, unlike the fastening portion 410a of the central core block 4B, the fastening portion 410a of the inner core block 4C is not formed with the flow path 401B (FIG. 3) communicating with the flow path 402C.

Similarly to the central core block 4B, the inner core block 4C is provided with the reference slot SL1 and the extension slot SL2. The extension slot SL2 has the flow path 403C extending radially outward from the outer diameter side end thereof. Further, the reference slot group 40A includes a plurality (six) of the reference slots SL1 arranged at equal intervals in the circumferential direction, and the extension slot group 40B includes a plurality (six) of the extension slots SL2 arranged at equal intervals in the circumferential direction. The reference slot group 40A and the extension slot group 40B are provided in the same number (for example, 3), and extend over a predetermined phase of 120°.

The reference slot group 40A of the central core block 4B and the reference slot group 40A of the inner core block 4C are arranged with phases shifted by 60° in the circumferential direction. Only by such phase shift, the slot groups 40A and 40B of the central core block 4B and the slot groups 40A and 40B of the inner core block 40C have the same shape. Therefore, the reference slot group 40A of the central core block 4B and the extension slot group 40B of the inner core block 4C are adjacent to each other in the axial direction, and the extension slot group 40B of the central core block 4B and the reference slot group 40A of the inner core block 4C are adjacent to each other in the axial direction. On the radially outer side of the reference slot group 40A, the flow path 402C extends in the circumferential direction over the entire region of the reference slot group 40A.

Although not illustrated, similarly to the outer core block 4A, the core block 4D at the axial end is provided with a plurality of slots 40 in the circumferential direction and the fastening portions 410a and 410b. However, unlike the outer core block 4A, the core block 4D is not provided with the flow path 400A.

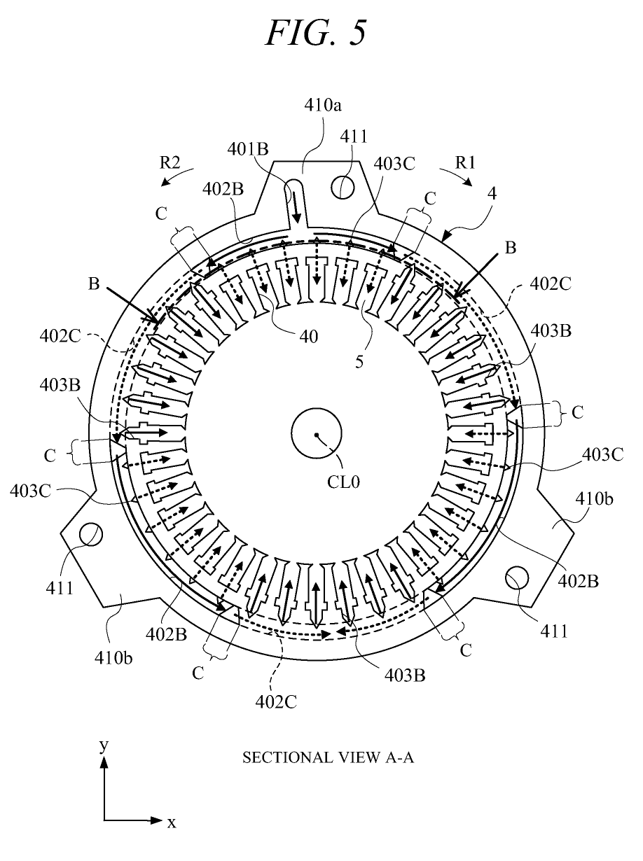

FIG. 5 is a cross-sectional view of the stator core 4 taken along line A-A in FIG. 1. In FIG. 5, illustration of the stator coil 5 is omitted for convenience. In FIG. 5, solid arrows and broken arrows in the flow path indicate the flow of the refrigerant. In particular, the solid arrow indicates the flow of the refrigerant in the flow path of the central core block 4B, and the broken arrow indicates the flow of the refrigerant in the flow path of the inner core block 4C.

As illustrated in FIG. 5, the refrigerant flowing from the flow path 400A of the outer core block 4A into the flow path 401B of the central core block 4B flows into the flow path 402B (solid arrow). In the flow path 402B, the refrigerant is divided into an arrow R1 direction (clockwise) and an arrow R2 direction (counterclockwise) in FIG. 5, and flows toward the end of the flow path 402B.

The refrigerant having flowed through the flow path 402B in the arrow R1 direction flows into the flow path 402C of the inner core block 4C via a communication region C (details will be described later). Thereafter, as indicated by broken arrows and solid arrows, the refrigerant flows through the flow path 402C of the inner core block 4C, the communication region C, the flow path 402B of the central core block 4B, the communication region C, and the flow path 402C of the inner core block 4C in this order. Similarly, the refrigerant having flowed through the flow path 402B in the arrow R2 direction flows through the communication region C, the flow path 402C of the inner core block 4C, the communication region C, the flow path 402B of the central core block 4B, the communication region C, and the flow path 402C of the inner core block 4C in this order.

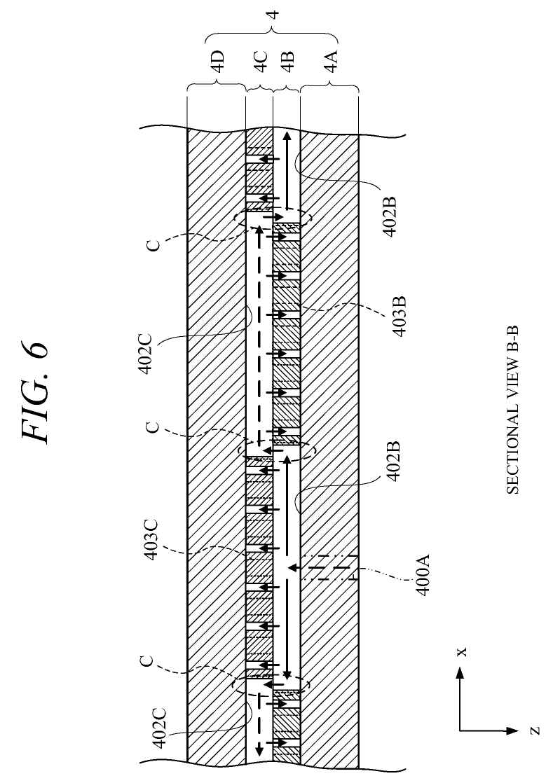

FIG. 6 is a cross-sectional view of the stator core 4 taken along line B-B extending in the circumferential direction of FIG. 5. Similarly to FIG. 5, in FIG. 6, solid arrows and broken arrows indicate the flow of the refrigerant. As illustrated in FIG. 6, the radially outer end region of the flow path 403C formed in the inner core block 4C faces the flow path 402B extending in the circumferential direction of the central core block 4B. Similarly, the radially outer end region of the flow path 403B formed in the central core block 4B faces the flow path 402C extending in the circumferential direction of the inner core block 4C. Therefore, a part of the refrigerant flowing through the flow path 402B flows into the radially outer end region of the flow path 403C. Similarly, a part of the refrigerant flowing through the flow path 402C flows into the radially outer end region of the flow path 403B. The refrigerant flowing into each of the flow paths 403B and 403C flows radially inward and flows into the slots 40 as illustrated in FIG. 5.

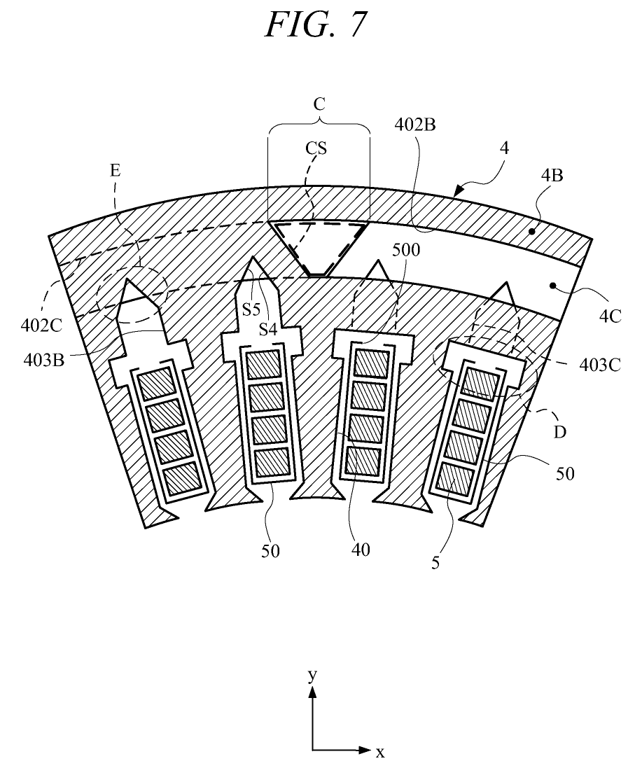

FIG. 7 is a cross-sectional view illustrating a configuration of a main part of the slot 40. As illustrated in FIG. 7, the stator coil 5 is, for example, a segment type coil having a substantially rectangular cross section. In the slot 40, a plurality of stator coils 5 are arranged along the radial direction. The plurality of stator coils 5 are covered over the entire circumference by an insulating sheet 50 such as an insulating paper or a synthetic resin sheet. At the radially outer end of the insulating sheet 50, an opening 500 is provided to face the flow paths 403B and 403C. The refrigerant having flowed through the flow paths 403B and 403C flows into the insulating sheet 50 through the opening 500, and directly cools the stator coil 5.

The insulating sheet 50 is provided to achieve electrical insulation between the stator coil 5 and the wall surface of the slot 40. The radially outer end surface of the stator coil 5 is exposed through the opening 500. Therefore, in order to secure an insulation distance from the wall surface of the slot 40, a bottom region D (dotted line) on the radially outer side of the slot 40 is formed such that a circumferential width of the slot 40 is enlarged.

In such a rotating electrical machine 1, the temperature of the stator coil 5 rises by the current flowing through the stator coil 5. In this case, cooling efficiency is low in a configuration in which a flow path is formed in the stator core, and the refrigerant is caused to flow in the flow path to cool the stator core, thereby indirectly cooling the stator coil. In this regard, in the present embodiment, the refrigerant having flowed through the flow paths 402B and 402C extending in the circumferential direction is introduced into the slots 40 via the flow paths 403B and 403C extending in the radial direction. Therefore, the stator coil 5 is directly cooled by the refrigerant, and the cooling efficiency of the stator coil 5 is high.

However, it is difficult to form a ring-shaped single flow path over substantially the entire circumference of the stator core 4. Therefore, in the present embodiment, the circumferential flow path 402B of the central core block 4B and the circumferential flow path 402C of the inner core block 4C are alternately connected in the circumferential direction, thereby forming a flow path over substantially the entire circumference of the stator core 4. Furthermore, in the present embodiment, the radial flow path 403B of the central core block 4B communicates with the circumferential flow path 402C of the inner core block 4C, and the radial flow path 403C of the inner core block 4C communicates with the circumferential flow path 402B of the central core block 4B, thereby supplying the refrigerant to all the slots 40.

As illustrated in FIG. 6, the circumferential flow path 402B of the central core block 4B and the circumferential flow path 402C of the inner core block 4C communicate with each other via the communication region C. Therefore, in the communication region C, the flow path is bent into a crank shape. As illustrated in FIG. 7, the flow paths 402B and 402C of the core blocks 4B and 4C are formed to overlap each other in the axial direction (z direction) in the communication region C. The area of the region surrounded by the broken line is the area where the flow paths 402B and 402C face each other, and corresponds to a flow path area CS of the communication region C. In the communication region C, since the flow path is bent in a crank shape, pressure loss is likely to occur. Therefore, among the plurality of slots 40 in the circumferential direction, the slot 40 having a longer distance from the flow path 401B on a refrigerant inlet side illustrated in FIG. 5 has a smaller flow rate of the refrigerant supplied to the slot 40. In this regard, in the present embodiment, in order to reduce the pressure loss in the communication region C, the flow path shape is set such that the flow path area increases.

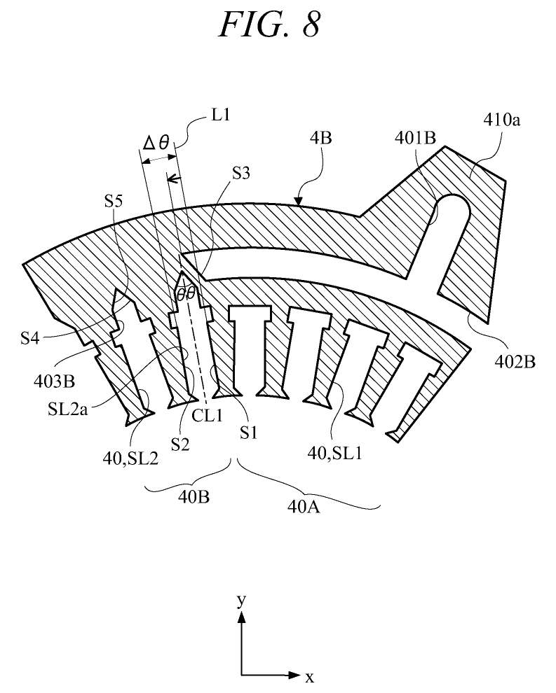

FIG. 8 is a diagram illustrating a positional relationship between the circumferential flow path 402B of the central core block 4B and the radial flow path 403B connected to the slot 40 (reference slot SL1, extension slot SL2) and the extension slot SL2. As illustrated in FIG. 8, among the plurality of extension slots SL2, the extension slot SL2 arranged at the circumferential end, that is, the extension slot SL2 arranged adjacent to the reference slot SL1 is defined as an end extension slot SL2a. In addition, a region (angular range) of the extension slot SL2 surrounded by the pair of side walls S1 and S2 in the circumferential direction is defined as an inner region Δθ of the extension slot SL2. The circumferential end of the flow path 402B is located within the inner region Δθ of the end extension slot SL2a. In other words, the circumferential end of the flow path 402B extends beyond an extension line L1 obtained by extending, radially outward, the side wall S1 on the flow path 402B side among the pair of side walls S1 and S2 of the end extension slot SL2a. Although not illustrated, the position of the circumferential end of the circumferential flow path 402C of the inner core block 4C is set similarly to the circumferential flow path 402B of the central core block 4B.

When the positions of the circumferential ends of the flow paths 402B and 402C extending in the circumferential direction are set as described above, it is possible to increase the flow path area CS in which the flow paths 402B and 402C overlap each other in the circumferential direction. As a result, the pressure loss in the communication region C can be suppressed, and a sufficient amount of refrigerant can be supplied to the slot 40 far away from the flow path 401B (for example, the slot 40 provided at the lower end of the stator core 4).

The flow path area CS is preferably set to be larger than the cross-sectional areas of the flow paths 402B and 402C (cross-sectional areas of cross sections cut in the axial direction) in consideration of the fact that the flow path is bent in a crank shape. Note that the axial lengths (thicknesses) of the core blocks 4B and 4C are set in consideration of the relationship between the cross-sectional areas of the flow paths 402B and 402C and the flow path area CS.

The refrigerant having flowed through the circumferential flow paths 402B and 402C flows into the plurality of radial flow paths 403B and 403C, and the inflow amount of the refrigerant into the flow paths 403B and 403C tends to increase as the flow path, among the plurality of flow paths 403B and 403C, is closer to the flow path 401B which is the upstream side of the flow of the refrigerant. In this regard, in the present embodiment, as illustrated in FIG. 7, the flow paths 403B and 403C are formed such that the cross-sectional area of an end region E (broken line) on the radially outer side of the flow paths 403B and 403C decreases as approaching the outer peripheral surface of the stator core 4.

Specifically, a pair of circumferential end surfaces S4 and S5 forming the flow paths 403B and 403C is formed in a tapered shape so as to approach each other radially outward. More specifically, as illustrated in FIG. 8, the flow paths 403B and 403C in the end region E are provided symmetrically with respect to an axis CL1 extending in the radial direction from the rotation center (axis CL0) of the rotor 3 (FIG. 1), and have the pair of end surfaces S4 and S5 (inclined surfaces) inclined at a predetermined angle θ with respect to the axis CL1. As a result, the area of the portion facing the flow paths 402B and 402C in the end region E (FIG. 7) decreases, and the pressure loss occurs. As a result, it is possible to suppress variations in the inflow amount of the refrigerant flowing from the flow paths 402B and 402C into the slots 40 via the flow paths 403B and 403C.

Furthermore, in the present embodiment, as illustrated in FIG. 8, when the extension slot SL2 at the circumferential end is defined as the end extension slot SL2a, an end surface S3 of the circumferential flow path 402B is formed in parallel with an end surface S4 on the flow path 402B side among the pair of end surfaces S4 and S5 of the flow path 403B extending radially outward from the end extension slot SL2a. As a result, it is possible to efficiently increase the flow path area CS while uniformly maintaining a width of a core region (electromagnetic steel plate region) separating the ends of the flow paths 402B and 402C and the ends of the flow paths 403B and 403C.

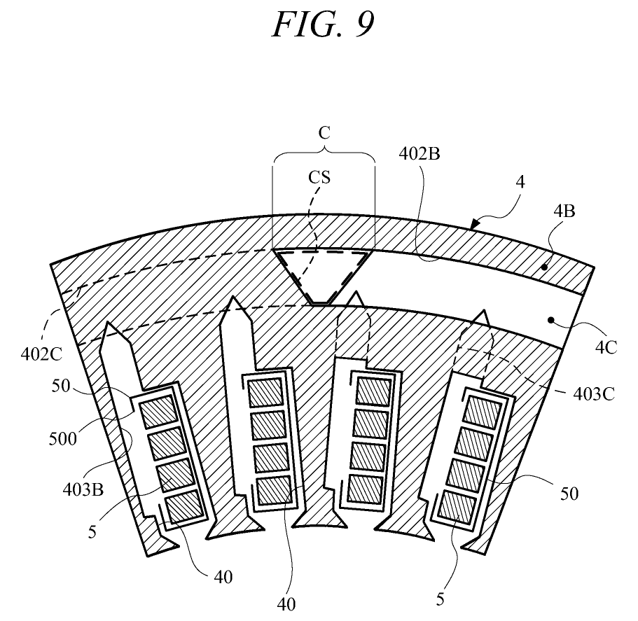

FIG. 9 is a diagram illustrating a modification of FIG. 7. In FIG. 7, the flow paths 403B and 403C are connected to the circumferential center portion of the slot 40, but in FIG. 9, the circumferential positions of the flow paths 403B and 403C are formed to be shifted from the circumferential center of the slot 40 to one side in the circumferential direction. Further, the opening 500 of the insulating sheet 50 is formed on one side surface in the circumferential direction so as to face the flow paths 403B and 403C. As a result, the area of the opening 500 can be increased as compared with the example of FIG. 7. Therefore, the supply amount of the refrigerant to the inside of the insulating sheet 50 can be increased, and the stator coil 5 can be efficiently cooled.

According to the present embodiment, the following operations and effects are achievable.

(1) A rotating electrical machine 1 includes a rotor 3 extending along an axial direction, and a stator core 4 having a plurality of core blocks 4A to 4D stacked in the axial direction and formed to surround the rotor 3 (FIG. 1). Among the plurality of core blocks 4A to 4D, each of the central core block (first core block) 4B and the inner core block (second core block) 4C adjacent to each other in the axial direction includes: a plurality of circumferential extension slot groups (first slot groups) 40B in which a plurality of circumferential extension slots (first slots) SL2 extending in the radial direction are provided; a plurality of circumferential reference slot groups (second slot groups) 40A in which a plurality of circumferential reference slots (second slots) SL1 extending in the radial direction are provided and that are arranged alternately in a circumferential direction with the plurality of circumferential extension slot groups 40B; a plurality of flow paths (first flow paths) 403B and 403C that communicate with the outer diameter side ends of the plurality of extension slots SL2 and extend radially outward; and a plurality of circumferential flow paths (second flow paths) 402B and 402C that extend in the circumferential direction on the radially outer side of the plurality of reference slot groups 40A (FIGS. 3 and 4). The plurality of extension slots SL2 include end extension slots SL2a arranged at circumferential ends (FIG. 8). The ends of the plurality of circumferential flow paths 402B and 402C are located within an inner region (slot region) Δθ obtained by extending the end extension slot SL2a radially outward (FIG. 8). The core blocks 4B and 4C are stacked such that the plurality of flow paths 403B of the central core block 4B communicate with one of the plurality of flow paths 402C of the inner core block 4C, and the plurality of flow paths 403C of the inner core block 4C communicates with one of the plurality of flow paths 402B of the central core block 4B (FIG. 5).

By setting the plurality of flow paths 402B and 402C in the circumferential direction as described above, the overlapping range in the circumferential direction between the flow paths 402B and 402C can be further increased, and the flow path area CS can be increased. As a result, the pressure loss in the communication region C can be reduced, and a sufficient amount of refrigerant can also be supplied to the slot 40 to the lower end side of the stator core 4 away from the flow path 401B on the refrigerant inlet side.

(2) An opposing area (flow path area CS) between the end region of the circumferential flow path 402B of the central core block 4B and the end region of the circumferential flow path 402C of the inner core block 4C is larger than an axial cross-sectional area of the flow paths 402B and 402C (FIG. 7). As a result, the pressure loss in the communication region C where the flow paths 402B and 402C communicate with each other can be suppressed low.

(3) The flow paths 403B and 403C extending in the radial direction have an end region (outer diameter end region) E formed such that a cross-sectional area decreases toward radial outside (FIG. 7). The end region E of the central core block 4B faces the circumferential flow path 402C of the inner core block 4C, and the end region E of the inner core block 4C faces the circumferential flow path 402B of the central core block 4B (FIG. 7). As a result, the opposing areas of the radial flow paths 403B and 403C and the circumferential flow paths 402C and 402B in the region E are reduced to generate pressure loss, and it is possible to suppress variations in the inflow amount of the refrigerant flowing from the flow paths 402C and 402B into the slots 40 via the flow paths 403B and 403C.

(4) The flow paths 403B and 403C in the end region E include a pair of end surfaces (inclined surfaces) S4 and S5 provided symmetrically with respect to an axis CL1 extending in the radial direction from an axis CL0 that is a rotation center of the rotor 3 and inclined at a predetermined angle θ with respect to the axis CL1 (FIG. 8). The circumferential end surfaces S3 of the flow paths 402B and 402C extending in the circumferential direction are formed substantially parallel to the end surfaces S4 on the side of the flow paths 402B and 402C among the pair of end surfaces S4 and S5 (FIG. 8). As a result, it is possible to efficiently increase the flow path area CS of the communication region C while uniformly maintaining a width of a core region separating the ends of the circumferential flow paths 402B and 402C and the ends of the radial flow paths 403B and 403C.

(5) The flow paths 402B and 402C extending in the circumferential direction have inner peripheral surfaces 402Ba and 402Ca and outer peripheral surfaces 402Bb and 402Cb on radially inner and outer sides (FIGS. 3 and 4). The flow paths 402B and 402C are formed such that the circumferential ends of the outer peripheral surfaces 402Bb and 402Cb protrude in the circumferential direction more than the circumferential ends of the inner peripheral surfaces 402Ba and 402Ca (FIGS. 3 and 4). As a result, it is possible to increase the area of the portion where the circumferential flow paths 402B and 402C and the radial flow paths 403C and 403B overlap.

(6) The central core block 4B is provided with a flow path (inlet flow path) 401B extending substantially upward from the top flow path 402B among the plurality of circumferential flow paths 402B in (FIG. 3). The plurality of core blocks 4A to 4D are configured such that a cooling medium is supplied to the flow path 401B from the outside of the stator core 4 (FIG. 1). As a result, the refrigerant can be easily supplied to the slot 40.

The above embodiment can be combined as desired with one or more of the above modifications. The modifications can also be combined with one another.

According to the present invention, it is possible to reduce pressure loss in a connection region of the flow paths in the circumferential direction.

Above, while the present invention has been described with reference to the preferred embodiments thereof, it will be understood, by those skilled in the art, that various changes and modifications may be made thereto without departing from the scope of the appended claims.

What is claimed is:

1. A rotating electrical machine comprising:
a rotor extending along an axial direction; and
a stator core having a plurality of core blocks stacked in the axial direction and formed to surround the rotor, wherein
the plurality of core blocks include a first core block and a second core block adjacent to each other in the axial direction,
each of the first core block and the second core block includes:
a plurality of first slot groups arranged in a circumferential direction, each first slot group including a plurality of first slots arranged in the circumferential direction, each first slot extending in a radial direction;
a plurality of second slot groups arranged in the circumferential direction and disposed alternately with each of the plurality of first slot groups in the circumferential direction, each second slot group including a plurality of second slots arranged in the circumferential direction, each second slot extending in the radial direction;
a plurality of first flow paths extending radially outward to communicate with end portions on a radially outer side of the plurality of first slots; and
a plurality of second flow paths arranged in the circumferential direction, each second flow path extending in the circumferential direction on the radially outer side of each second slot group,
the plurality of first slots include end first slots disposed at circumferential end portions,
end portions of the plurality of second flow paths of the first core block are located within slot regions defined by radially outward extensions of the end first slots of the second core block,
end portions of the plurality of second flow paths of the second core block are located within slot regions defined by radially outward extensions of the end first slots of the first core block, and
the first core block and the second core block are stacked such that the plurality of first flow paths of the first core block communicate with one of the plurality of second flow paths of the second core block, and the plurality of first flow paths of the second core block communicate with one of the plurality of second flow paths of the first core block.

2. The rotating electrical machine according to claim 1, wherein
an opposing area between end regions of the plurality of second flow paths of the first core block and end regions of the plurality of second flow paths of the second core block is larger than a cross-sectional area taken along the axial direction of the plurality of second flow paths.

3. The rotating electrical machine according to claim 1, wherein
each of the plurality of first flow paths includes an outer diameter end region formed so that a cross-sectional area thereof decreases toward the radially outer side, and
the outer diameter end region of one of the first core block or the second core block is opposed to the plurality of second flow paths of the other of the first core block and the second core block.

4. The rotating electrical machine according to claim 3, wherein
the plurality of first flow paths in the outer diameter end region include a pair of inclined surfaces provided symmetrically with respect to an axis extending radially from a rotation center of the rotor and inclined at a predetermined angle with respect to the axis, and
circumferential end faces of the plurality of second flow paths are formed substantially parallel to an inclined surface closer to the plurality of second flow path among the pair of inclined surfaces.

5. The rotating electrical machine according to claim 1, wherein
each of the plurality of second flow paths includes an inner peripheral surface and an outer peripheral surface on a radially inner side and a radially outer side, respectively, and formed such that a circumferential end portion of the outer peripheral surface protrudes in the circumferential direction farther than a circumferential end portion of the inner peripheral surface.

6. The rotating electrical machine according to claim 1, wherein
the first core block is provided with an inlet flow path extending substantially upward from an uppermost second flow path among the plurality of second flow paths, and
the plurality of core blocks are configured such that a cooling medium is supplied to the inlet flow path from an outside of the stator core.
